(19) United States
(12) Patent Application Publication
(10) Pub. No.: US 2026/0340144 A1
(43) Pub. Date: Oct. 29, 2026

(54) METHODS FOR ANALYZING TRUE POSITIVE OR FALSE POSITIVE FOR SECURITY ALERTS USING LANGUAGE MODEL

(71) Applicant: Logpresso Inc., Seoul (KR)

(72) Inventor: Bongyeol YANG, Seoul (KR)

(21) Appl. No.: 19/419,047

(22) Filed: Dec. 14, 2025

(30) Foreign Application Priority Data
Dec. 23, 2024 (KR) 10-2024-0194019
Jan. 21, 2025 (KR) 10-2025-0008723

(51) Int. Cl. G06F 21/57

(52) U.S. Cl. CPC G06F 21/577; G06F 2221/034

(57) ABSTRACT

A method for analyzing true/false positive security alerts includes collecting, by a log collection module, an alert payload transmitted by a security system; extracting, by a threat detection module, features from the payload received from the log collection module as analysis tags based on context of the payload according to the configuration of a threat detection policy; classifying, by the threat detection module, true/false positives using a true/false positive determination module based on payload analysis tags according to the configuration of the threat detection policy and generating a ticket through a ticket management module based on the classification; querying, by a playbook execution module, the language model to convert the true/false positive determination and the list of analysis tags into a natural language-based explanation according to the playbook configuration; and recording, by the playbook execution module, the analysis content generated as the output of the language model into the ticket.

### CROSS-REFERENCE TO RELATED APPLICATIONS

This application claims priority from Korean Patent Application Nos. 10-2024-0194019 filed on Dec. 23, 2024 and 10-2025-0008723 filed on Jan. 21, 2025. The aforementioned applications are incorporated herein by reference in their entireties.

### TECHNICAL FIELD

The present disclosure relates to a method for analyzing true positive or false positive for security alerts, which extracts features from an alert log generated by a security module and explains the reason for the true positive or false positive determination for the alert in natural language.

### RELATED ART

Since integrated security control systems collect and analyze several terabytes of logs per day, control center personnel experience many difficulties in analyzing the large volume of alerts generated by security equipment. Alerts from security equipment such as web application firewalls have a significant false positive rate, leading to control center personnel unnecessarily spending a lot of time on inaccurate alerts. Furthermore, confirming whether a security alert has detected a real threat or is a false detection requires long experience and up-to-date knowledge about vulnerabilities. Generative AI technologies, such as large language models, have learned large-scale data and can analyze packet payloads at a level similar to humans; however, there are limitations in adjusting the directionality of payload analysis as intended and in providing answers that reflect the latest information since the time of large language model training.

The present disclosure proposes a method for neutrally extracting characteristic information from the payload regardless of the model or manufacturer of the security equipment that generated the alert, and for generating consistent, accurate, and detailed true/false positive determinations and explanations of the basis for the determination for security equipment alerts by transmitting feature information such as data fragments to be noted in the payload and CVE vulnerability information, along with the true/false positive status, to a large language model.

### PRIOR ART DOCUMENT

Korean Laid-Open Patent Publication No. 10-2022-0084865 (Publication Date: Jun. 21, 2022)

### SUMMARY

The present disclosure aims to solve the problems of the conventional technology described above by providing a method that can explain true/false positive information of a security alert in natural language using a language model.

A computer-implemented method for analyzing true/false positive security alerts of the present disclosure is executed in an environment comprising a log collection module, a threat detection module, a ticket management module, a playbook execution module, a payload feature extraction module, a true/false positive determination module, and a language model. The method of the present disclosure comprise a first step where the log collection module collects the alert payload transmitted by a security system; a second step where the threat detection module extracts features from the payload received from the log collection module as analysis tags based on context of the payload according to the configuration of a threat detection policy; a third step where the threat detection module classifies true/false positives using the true/false positive determination module based on the payload analysis tags according to the configuration of the threat detection policy and generates a ticket through the ticket management module based on the classification; a fourth step where the playbook execution module queries the language model to convert the true/false positive determination and the list of analysis tags into a natural language-based explanation according to the playbook configuration; and a fifth step where the playbook execution module records the analysis content generated as the output of the language model in the fourth step into the ticket through the ticket management module.

The computer-implemented method for analyzing true/false positive security alerts according to the present disclosure can comprise a sixth step of generating the language model's response as a ticket memo and adding the response to the ticket; and a seventh step of setting the true/false positive determination result as the true/false positive result of the ticket.

The threat detection module can operate based on a threat detection policy; the threat detection policy can be configured using the payload feature extraction module and the true/false positive determination module; and the playbook execution module is a playbook workflow module that receives and processes a newly generated ticket from the ticket management module (60) according to a pre-configured flowchart.

The present disclosure provides a computer-implemented system comprising one or more processors and one or more non-transitory computer-readable media storing computer-executable instructions that, when executed, cause the one or more processors to perform the above-mentioned method.

The present disclosure also provides a computer program product comprising one or more non-transitory computer-readable storage media and program instructions stored in at least one of the one or more non-transitory storage media, the program instructions executable by a processor to cause the processor to perform the above-mentioned method.

The present disclosure provides the effect of a method that uses a language model to explain and analyze the true/false positive determination result for a security module's alert log or threat ticket in natural language, linked with payload feature information.

### BRIEF DESCRIPTION OF THE DRAWINGS

FIG. 1 is an example of the environment in which the present disclosure is executed;

FIG. 2 is an example of an alert log generated when the security system is a web application firewall;

FIG. 3 is an example of the output when a payload analysis query command is applied to an alert log;

FIG. 4 is a flowchart of the security alert true/false positive analysis method according to the present disclosure;

FIG. 5 is a table of feature information extracted from the payload, true/false positive tendencies, and examples;

FIG. 6 is an example of a true/false positive analysis explanation generated based on the query content regarding true/false positive analysis to the language model and the language model's response thereto.

It should be understood that the above-referenced drawings are not necessarily to scale, presenting a somewhat simplified representation of various preferred features illustrative of the basic principles of the disclosure. The specific design features of the present disclosure will be determined in part by the particular intended application and use environment.

### DETAILED DESCRIPTION

Hereinafter, the present disclosure will be described in detail with reference to the accompanying drawings. As those skilled in the art would realize, the described embodiments may be modified in various different ways, all without departing from the spirit or scope of the present disclosure. Further, throughout the specification, like reference numerals refer to like elements.

In this specification, the order of each step should be understood in a non-limited manner unless a preceding step must be performed logically and temporally before a following step. That is, except for the exceptional cases as described above, although a process described as a following step is preceded by a process described as a preceding step, it does not affect the nature of the present disclosure, and the scope of rights should be defined regardless of the order of the steps. In addition, in this specification, “A or B” is defined not only as selectively referring to either A or B, but also as including both A and B. In addition, in this specification, the term “comprise” has a meaning of further including other components in addition to the components listed.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprise” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. The term “coupled” denotes a physical relationship between two components whereby the components are either directly connected to one another or indirectly connected via one or more intermediary components.

The term “module” or “unit” means a logical combination of a universal hardware and a software carrying out required function.

The terms “first,” “second,” or the like are herein used to distinguishably refer to same or similar elements, or the steps of the present disclosure and they may not infer an order or a plurality.

In this specification, the essential elements for the present disclosure will be described and the non-essential elements may not be described. However, the scope of the present disclosure should not be limited to the invention including only the described components. Further, it should be understood that the invention which includes additional element or does not have non-essential elements can be within the scope of the present disclosure.

The method of the present disclosure can be carried out by an electronic arithmetic device.

The electronic arithmetic device can be a device such as a computer, tablet, mobile phone, portable computing device, stationary computing device, server computer etc. Additionally, it is understood that one or more various methods, or aspects thereof, may be executed by at least one processor. The processor may be implemented on a computer, tablet, mobile device, portable computing device, etc. A memory configured to store program instructions may also be implemented in the device(s), in which case the processor is specifically programmed to execute the stored program instructions to perform one or more processes, which are described further below. Moreover, it is understood that the below information, methods, etc. may be executed by a computer, tablet, mobile device, portable computing device, etc. including the processor, in conjunction with one or more additional components, as described in detail below. Furthermore, control logic may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

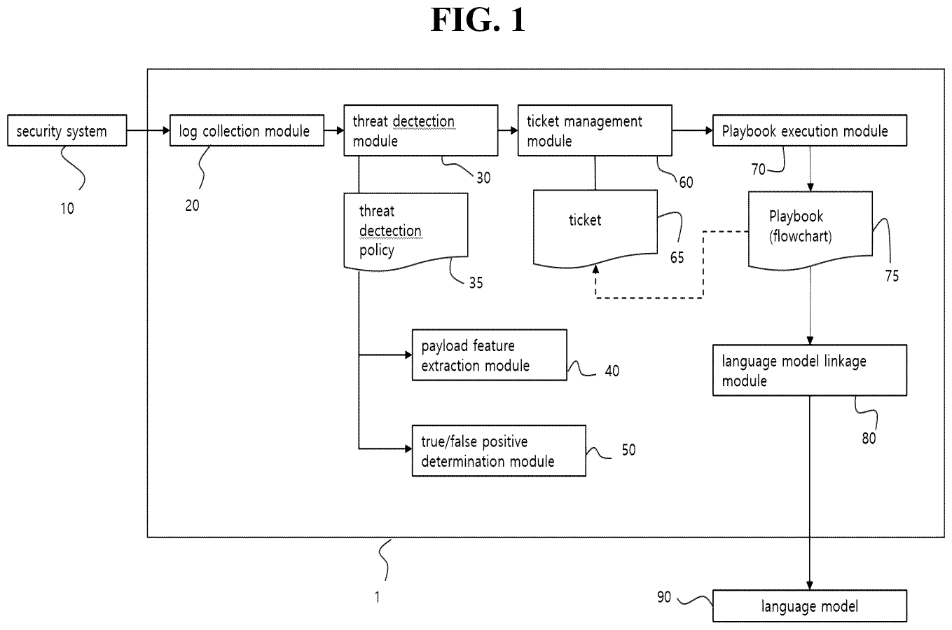

As shown in FIG. 1, the environment where the present disclosure is carried out includes a security system (10), an integrated security control system (1), and a language model (90). The integrated security control system (1) includes a log collection module (20), a threat detection module (30), a payload feature extraction module (40), a true/false positive determination module (50), a ticket management module (60), a playbook execution module (70), a language model linkage module (80), and a language model (90).

The language model (90) may be a large language model (LLM) or a small language model (sLLM). Also, the language model (90) may be provided in the same system or separated as an external entity.

The security system (10) may be, for example, a web application firewall, an intrusion detection system (IDS), an intrusion prevention system (IPS), an endpoint detection and response system (EDR), or the like. The security system (10) can generate an alert log that includes a payload. The payload can include the raw text of an HTTP request for a web application firewall, binary packet data for an intrusion prevention system, and an operating system command line suspected of malicious behavior for an endpoint detection and response system.

The log collection module (20) collects logs of the security system containing the payload through various means such as SYSLOG, SNMP Trap, and Webhook, and transfers the data to a data storage system or the threat detection module (30).

The threat detection module (30) executes the payload feature extraction module (40) according to the configuration of the threat detection policy (35) to extract features from the payload transferred through the log collection module (20) as analysis tags, enables the true/false positive determination module (50) to determine the true/false positive status based on the analysis tags, and calls the ticket management module (60) to generate a ticket (65).

The ticket management module (60) manages ticket objects that a security analyst needs to check and delivers the newly generated ticket to the module waiting for ticket creation.

The playbook execution module (70) receives the newly generated ticket (65) from the ticket management module (60) in real-time according to the playbook configuration (75) and processes the designated task. The playbook (75) can be configured to call the language model (90). In the embodiment, the AI true/false positive determination result, the list of analysis tags, and the payload recorded in the ticket (65) are transmitted as parameters to the language model linkage module (80), and then the language model linkage module (80) calls the language model (90) to respond the true/false positive analysis result in natural language. The analysis result can be included in the ticket (65) in the form of a memo.

The payload feature extraction module (40) is implemented in the form of a query command in one embodiment and extracts feature information from the payload contained in the alert log, threat detection event, or ticket (65). The extracted information may include analysis tags, highlight, and field of decoded strings. The highlight field value refers to a partial string or binary in the payload which is judged to be a threat, and the field value of decoded strings refers to information that has been de-obfuscated into an easy-to-read format, where the original data was previously concealed by methods like BASE64, URL encoding, or LDAP expressions.

The true/false positive determination module (50) determines whether the alert from the security system (10) is a true positive or a false positive based on the extracted analysis tags. The true/false positive determination module (50) can determine the true/false positive status based on an AI model trained using analysis tags for true positive tendencies and false positive tendencies, for example.

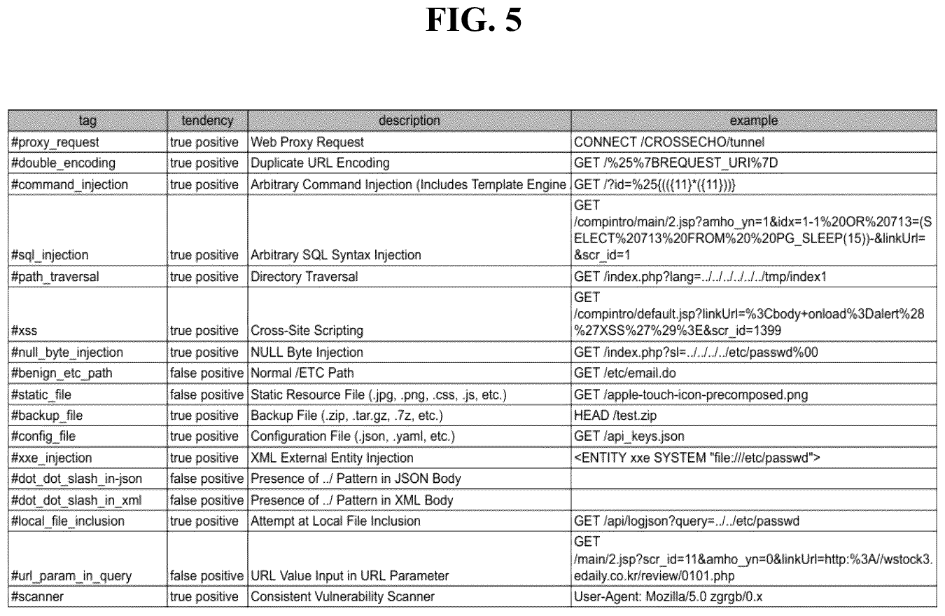

FIG. 5 shows the analysis tags extracted as features, the true/false positive tendencies, their descriptions, and examples of when the corresponding tag is assigned.

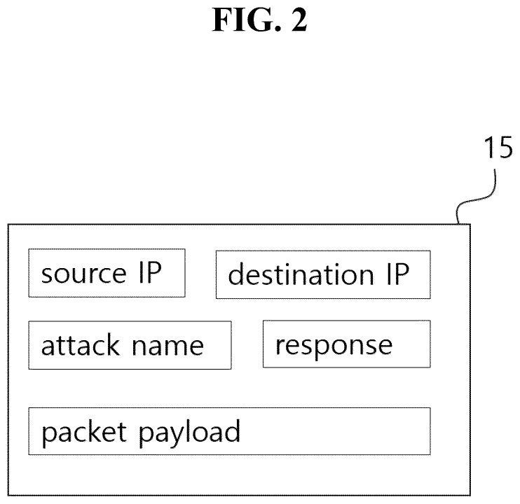

FIG. 2 shows the structure of the alert log (15) generated when the security system (10) is a web application firewall. The web application firewall alert log (15) includes the source IP, destination IP, attack name (signature), action (response), and packet payload (raw data).

A web application firewall analyzes HTTP traffic to detect or block threats, but false positives may occur, as in the following examples, where no actual threat exists.

```
  POST /icignal/interface HTTP/1.1
  {“interfaceId”:“EXT_3001”,“reqObj”:{“Search_Type”:“10”,“Search_Value”:“NC+TI7p7i
CxELXu4AvWGPFOEBPPQJ+Mo5skr1fwrRKMKxa6SXq6xsWMKHXdwq1R0ljZKmrK52Os
pz2ltzCONUg==”}}
```

The above example is a false positive that occurred because the web application firewall detected the nc command which is used to run the netcat program, as simple pattern matching.

The example below is a case where the web application firewall falsely detected the string floor included in a JSON string as an SQL injection.

POST /logs/ HTTP/1.1
{“review_text”: “Pros:\n
-Great location (2mins beside Ximen)\n
-Famous Cantonese restaurant in the same building & Ah Zong Mian Xian
just downstairs of the building \n
-High floor (10th)\n
...
“funnel”:“review”,
“review_id”:“<REDACTED>”
}

The payload feature extraction module (40) precisely distinguishes the causes of such false positives by outputting true positive and false positive features in the form of analysis tags, as shown in FIG. 5.

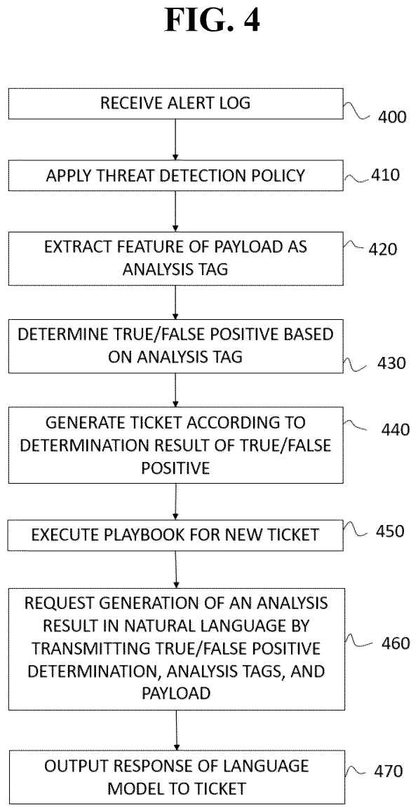

FIG. 4 shows the flowchart of true/false positive analysis method for the security alert according to the present disclosure. The overall process is shown, where after the log collection module (20) of the integrated security control system (1) receives an alert log, features of the payload are extracted as analysis tags according to the threat detection policy (35); a true/false positive determination is made based on the analysis tags; and after generating a ticket (65), a large language model is called by the playbook execution module (70) to generate an analysis result in natural language and add it as a memo to the ticket (65).

In step (400), the alert log (15) generated by the security system (10) is received.

When the log collection module (20) receives the alert log (15), the threat detection module (30) receives and processes the alert log according to the threat detection policy (35). The threat detection policy (35) may be configured to include calling the payload feature extraction module (40) and the true/false positive determination module (50). In one embodiment, the payload feature extraction module (40) and the true/false positive determination module (50) can be implemented in the form of a single query command. For example, the two steps (420 and 430) of extracting features of the payload as analysis tags and determining the true/false positive status based on the analysis tags can be implemented with a single “ml-scan-http-request” query command.

The “ml-scan-http-request” command analyzes the presented payload and returns the true/false positive determination (verdict), analysis tags (tags), CVE ID, highlight, and decoded strings.

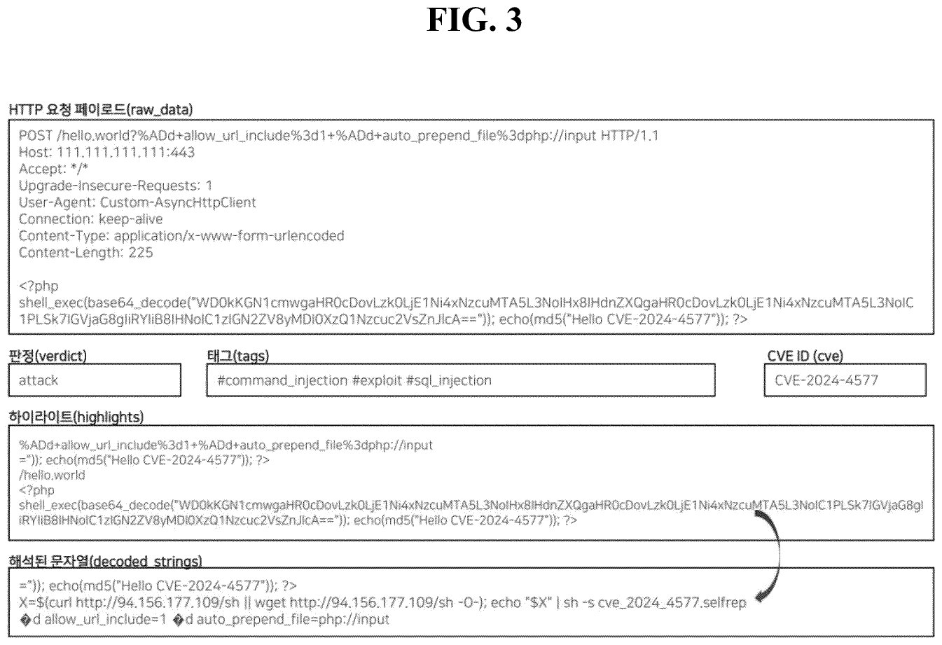

FIG. 3 shows the payload string inputted for the true/false positive determination and the information returned by applying the ml-scan-http-request command to it.

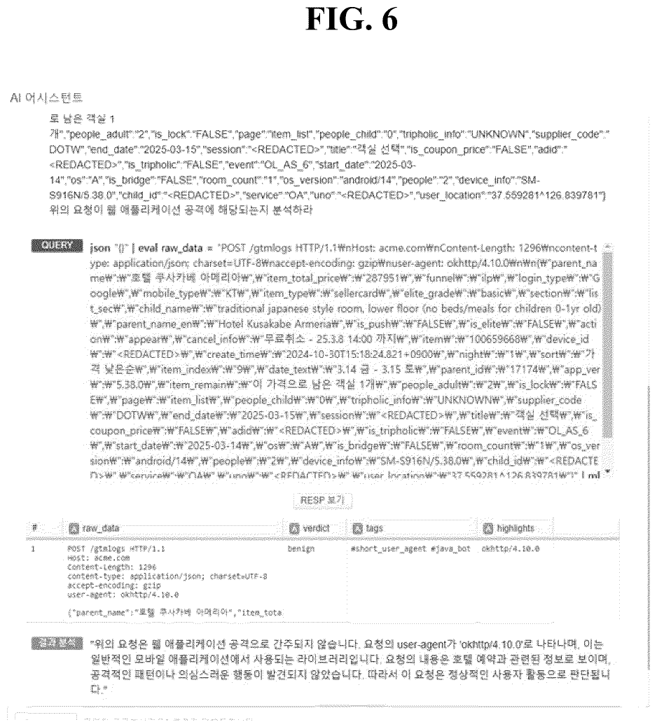

In step (440), generated is a ticket (65) which includes the payload that was analyzed, the extracted analysis tags, and the true/false positive determination result. In step (450), the playbook execution module (70) immediately executes the playbook (75) for the newly generated ticket (65). In step (460), the language model linkage module (80) is called to request the generation of an analysis result in natural language with transmitting the true/false positive determination, analysis tags, and payload as parameters. Finally, step (470) completes the entire process of performing true/false positive analysis in natural language by adding the analysis result generated by the language model (90) as a ticket memo. FIG. 6 shows an example of the query entered by the user to the language model linkage module (80) for the natural language analysis of the security alert's true/false positive status and the language model's (90) response to it.

Although the present disclosure has been described with reference to accompanying drawings, the scope of the present disclosure is determined by the claims described below and should not be interpreted as being restricted by the embodiments and/or drawings described above. It should be clearly understood that improvements, changes and modifications of the present disclosure disclosed in the claims and apparent to those skilled in the art also fall within the scope of the present disclosure. Accordingly, this description is to be taken only by way of example and not to otherwise limit the scope of the embodiments herein.

What is claimed is:

1. A computer-implemented method for analyzing true/false positive security alerts, executed in an environment comprising a log collection module, a threat detection module, a ticket management module, a playbook execution module, a payload feature extraction module, a true/false positive determination module, and a language model, the method comprising:
a first step where the log collection module collects the alert payload transmitted by a security system;
a second step where the threat detection module extracts features from the payload received from the log collection module as analysis tags based on context of the payload according to the configuration of a threat detection policy;
a third step where the threat detection module classifies true/false positives using the true/false positive determination module based on the payload analysis tags according to the configuration of the threat detection policy and generates a ticket through the ticket management module based on the classification;
a fourth step where the playbook execution module queries the language model to convert the true/false positive determination and the list of analysis tags into a natural language-based explanation according to the playbook configuration; and
a fifth step where the playbook execution module records the analysis content generated as the output of the language model in the fourth step into the ticket through the ticket management module.

2. The computer-implemented method for analyzing true/false positive security alerts of claim 1, further comprising:
a sixth step of generating the language model's response as a ticket memo and adding the response to the ticket; and a seventh step of setting the true/false positive determination result as the true/false positive result of the ticket,
wherein the threat detection module operates based on a threat detection policy,
wherein the threat detection policy is configured using the payload feature extraction module and the true/false positive determination module, and
wherein the playbook execution module is a playbook workflow module that receives and processes a newly generated ticket from the ticket management module according to a pre-configured flowchart.

3. A computer-implemented system comprising one or more processors and one or more non-transitory computer-readable media storing computer-executable instructions that, when executed, cause the one or more processors to perform a method comprising:
a first step where the log collection module collects the alert payload transmitted by a security system;
a second step where the threat detection module extracts features from the payload received from the log collection module as analysis tags based on context of the payload according to the configuration of a threat detection policy;
a third step where the threat detection module classifies true/false positives using the true/false positive determination module based on the payload analysis tags according to the configuration of the threat detection policy and generates a ticket through the ticket management module based on the classification;
a fourth step where the playbook execution module queries the language model to convert the true/false positive determination and the list of analysis tags into a natural language-based explanation according to the playbook configuration; and
a fifth step where the playbook execution module records the analysis content generated as the output of the language model in the fourth step into the ticket through the ticket management module.

4. A computer program product comprising one or more non-transitory computer-readable storage media and program instructions stored in at least one of the one or more non-transitory storage media, the program instructions executable by a processor to cause the processor to perform a method comprising:
a first step where the log collection module collects the alert payload transmitted by a security system;
a second step where the threat detection module extracts features from the payload received from the log collection module as analysis tags based on context of the payload according to the configuration of a threat detection policy;
a third step where the threat detection module classifies true/false positives using the true/false positive determination module based on the payload analysis tags according to the configuration of the threat detection policy and generates a ticket through the ticket management module based on the classification;
a fourth step where the playbook execution module queries the language model to convert the true/false positive determination and the list of analysis tags into a natural language-based explanation according to the playbook configuration; and
a fifth step where the playbook execution module records the analysis content generated as the output of the language model in the fourth step into the ticket through the ticket management module.
